(19) United States
(12) Patent Application Publication
(10) Pub. No.: US 2004/0119347 A1
(43) Pub. Date: Jun. 24, 2004

(54) Rotating electric machine

(75) Inventors: Tetsuo Fujigaki, Hitachi (JP); Hidekazu Midorikawa, Hitachi (JP); Shuji Mizutani, Hitachi (JP); Kazuo Nishihama, Hitachi (JP); Shuichi Ishizawa, Hitachi (JP); Katsuji Takei, Juo (JP); Satoru Takaboshi, Takahagi (JP); Shirou Kikuchi, Hitachiota (JP); Isoo Sugano, Hitachi (JP); Masanori Matsumoto, Takahagi (JP); Kenji Takahashi, Abiko (JP); Shinichi Ozawa, Hitachi (JP)

Correspondence Address: CROWELL & MORING LLP, INTELLECTUAL PROPERTY GROUP, P.O. BOX 14300, WASHINGTON, DC, 20044-4300, US

(73) Assignees: Hitachi, Ltd.; Hitachi Car Engineering Co., Ltd.

(21) Appl. No.: 10/732,253

(22) Filed: Dec. 11, 2003

Related U.S. Application Data
(62) Division of application No. 10/322,799, filed on Dec. 19, 2002.

(30) Foreign Application Priority Data
Dec. 19, 2001 (JP) 2001-385381
Dec. 19, 2001 (JP) 2001-385380
Dec. 19, 2001 (JP) 2001-385379

(51) Int. Cl. H02K 9/00; H02K 5/00

(52) U.S. Cl. 310/58; 310/217; 310/89; 310/254

(57) ABSTRACT

In order to provide a rotating electric machine which reduces vibration, noise and temperature rise and eases assembling work thereof through an improvement of a frame structure and a securing method between a stator iron core and the frame. In a rotating electric machine comprising a stator iron core 6 having a stator winding, a frame 1 having intermediate plates 2 for securing the stator iron core 6 to the frame 1, a rotor iron core 5 having a rotor winding, the intermediate plates (brackets) 2 which rotatably support the rotor at both sides in the frame axial direction under the condition of accommodating the stator iron core 6 and the rotor iron core 5 in the frame 1, cooling fans 4 for ventilation through rotation together with a rotor shaft 3, and a shaft portion extending from the brackets for directly coupling to a load, wherein, the securing between the frame 1 and the stator iron core 6 is performed by a welding structure at a welding portion 9.

### FIELD OF THE INVENTION

The present invention relates to a rotating electric machine.

### BACKGROUND ART

A rotating electric machine comprises a rotor and a stator and which are relatively rotated each other. For example, such is disclosed in JP-A-8-9571 (1996). A rotor and a stator are accommodated in a frame, however, in general, the stator is not directly secured to the frame, but secured thereto via an intermediate plate.

Further, since the stator and the rotor are heated because of iron loss and copper loss, fans are provided inside the machine. At the both ends of the frame, brackets are provided and the fans are located between the rotor and the brackets. An example, in which the rotor is rotatably supported by the brackets via bearings, is disclosed in JP-A-4-325850 (1992).

When fans are provided between the bearings and the rotor in order to cool the rotor and the stator, the total length of the stator in axial direction is prolonged.

Generally, in order to ease accommodation of the rotor, the bracket is frequently divided into two parts. On the other hand, the stator is generally secured to the frame via shrink fitting. However, the working difficultly of such shrink fitting frequently caused problems.

Now, through the attachment of the fans to the rotor and through rotation of the fans together with the rotor, the heating of the machine is suppressed, in particular, noting to cooling of the coil ends, guides were provided at the outside of the cooling fans. Such is for example is disclosed in JP(U)-A-61-98363 (1986).

However, the provision of such guides hinders the flow of cooling medium and rather reduces the cooling efficiency.

### SUMMARY OF THE INVENTION

An object of the present invention is to provide a rotating electric machine which ensures a sufficient mechanical strength even for a machine having a long axial length because of provision of fans, and permits an improvement in workability thereof.

Another object of the present invention is to provide a rotating electric machine which permits an improvement of cooling efficiency.

In order to achieve at least one of the above objects, in a rotating electric machine according to the present invention which includes a frame, a stator accommodated in the frame, a rotor accommodated in the frame so as to oppose to the stator in the frame and fans provided at the outside of the rotor in the axial direction thereof in the frame and being rotatable together with the rotor and in which the stator is secured to the frame via intermediate plates, wherein the securing is performed by welding the stator to the intermediate plates.

Alternatively, in a rotating electric machine according to the present invention which includes a frame, brackets provided at the side faces of the frame, a rotor rotatably supported by the brackets via bearings, a stator held in the frame so as to surround the rotor, fans disposed between the rotor and the brackets and being rotatable together with the fans and in which the brackets are formed so as to permit division thereof, wherein at least one of the divided parts of the brackets is formed integral with the frame.

Further, alternatively, in a rotating electric machine according to the present invention which includes a stator iron core, a stator winding provided at the stator iron core, a rotor iron core opposing to the stator iron core and being rotatable, a rotor winding provided at the rotor iron core, fans being rotatable together with the rotor iron core and fit spacers provided at the stator winding, wherein the fit spacers are attached at a position extending from the outside of the cooling fans.

### BRIEF DESCRIPTION OF THE DRAWINGS

FIG. 1 is a vertical cross sectional view of a rotating electrical machine representing an embodiment according to the present invention;

FIG. 2 is a detailed perspective view of the rotating electric machine representing the embodiment according to the present invention;

FIG. 3 is a vertical cross sectional view of a rotating electric machine representing a second embodiment according to the present invention;

FIG. 4 is a detailed perspective view of the bracket portion in the rotating electric machine representing the second embodiment according to the present invention;

FIG. 5 is a vertical cross sectional view of a rotating electric machine representing a third embodiment according to the present invention; and

FIG. 6 is a detailed view of the rotating electric machine representing the third embodiment according to the present invention.

### DESCRIPTION OF THE PREFERRED EMBODIMENTS

Embodiments of the present invention will be explained with reference to the drawings.

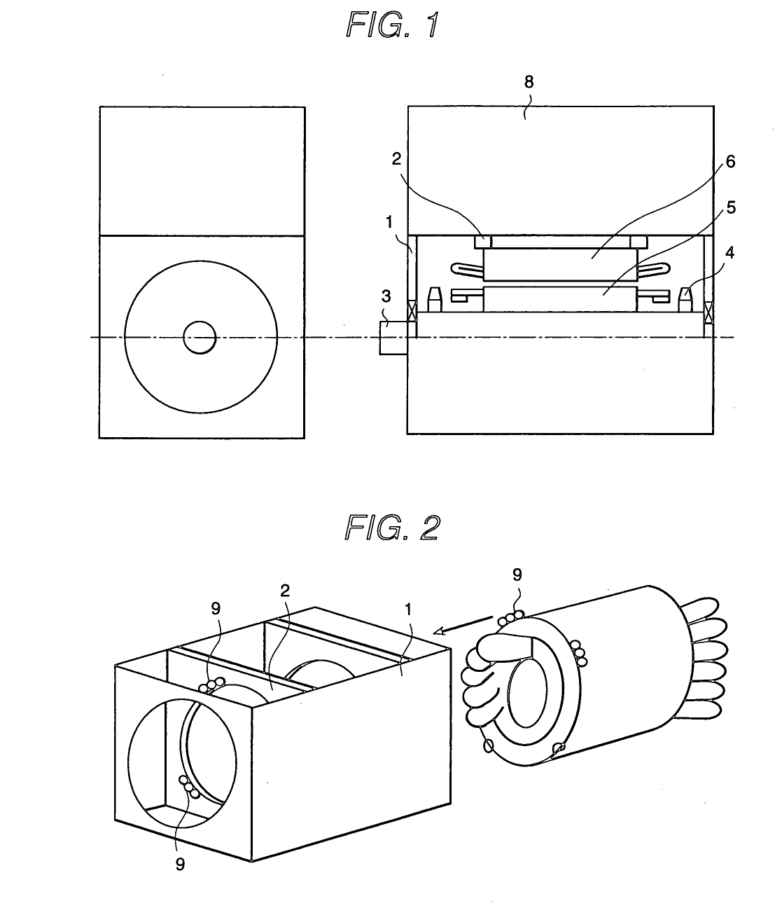

FIG. 1 shows a structure of a rotating electric machine in a vertical cross sectional view. FIG. 2 shows a detail of securing a stator iron core with a frame. The rotating electric machine is constituted by a stator iron core 6 having a stator winding, a frame 1 having intermediate plates 2 for securing the stator iron core 6 to the frame 1, a rotor iron core 5 having a rotor winding, the intermediate plates (brackets) 2 which rotatably support the rotor at the both sides in the frame axial direction under the condition of accommodating the stator iron core 6 and the rotor iron core 5 in the frame 1 and cooling fans 4 for ventilation through rotation together with a rotor shaft 3.

Now, for example, if the frame 1 and the stator iron core 6 are secured as in a conventional manner by shrink fitting between the intermediate plates 2 and axial direction arms and the stator iron core 6, the stator iron core 6 is completely secured by the axial direction arms in the number of 6-8 disposed along the frame circumferential direction, however, as the result thereof, vibration of the stator iron core 6 caused during operation of the rotating electric machine is directly transmitted to the frame 1, thereby, the noise and vibration of the entire rotating electric machine are amplified. In this instance, through the shrink fitting between the frame 1 and the stator iron core 6, all of the deformation modes due to electro magnetic vibration during operation of the rotating electric machine are directly transmitted to the frame 1, and the noise and vibration of the entire rotating electric machine are increased.

Further, in this instance, the flow of the cooling wind of the rotating electric machine tends to be disturbed by the axial direction arms in the number of 6-8 pieces disposed along the circumferential direction of the frame 1 and the area of cooling surface of the stator iron core 6 is also decreased by the axial direction arms.

In this sense, the rotating electric machine in FIG. 1 embodiment which includes a stator iron core 6 having a stator winding, a frame 1 having intermediate plates 2 for securing the stator iron core 6 to the frame 1, a rotor iron core 5 having a rotor winding, the intermediate plates (brackets) 2 which rotatably support the rotor at the both sides in the frame axial direction under the condition of accommodating the stator iron core 6 and the rotor iron core 5 in the frame 1, cooling fans 4 for ventilation through rotation together with a rotor shaft 3, and a shaft portion extending from the brackets 2 for directly coupling to a load, wherein, the securing between the frame 1 and the stator iron core 6 is performed by a welding structure as shown at a welding portion 9.

Namely, other than the conventional shrink fit securing of the stator iron core 6 with the frame 1 via the intermediate plates 2 and the axial direction arms, in the present embodiment, the securing between the frame 1 and the stator iron core 6 is performed by welding by the stator iron core 6 and the intermediate plates 2 included in the frame 1 as shown in FIGS. 1 and 2.

A rotating electric machine is always accompanied with vibration during operation thereof and is required to reduce the total vibration in the rotating electric machine. In such instance, it is effective to take a measure in which transmission of vibration from the stator iron core can be reduced as much as possible.

For this purpose, in place of the complete securing of the stator iron core 6 to the frame 1 via the axial direction arms, it is effective to reduce the vibration transmission through partial contact by welding between the intermediate plates 2 and the stator iron core 6. Further, with regard to deformation due to electro magnetic vibration which is always caused during operation of the machine, in order not to transmit the deformation modes to the frame 1, if the pole pitch of the rotating electric machine is selected in about 0-60%, the deformation modes due to electro magnetic vibration is hard to be transmitted to the frame 1.

Still further, since the flow of the cooling wind of the rotating electric machine tends to be disturbed by the axial direction arms in the number of 6-8 pieces disposed along the circumferential direction of the frame and the area of cooling surface of the stator iron core 6 is also decreased by the axial direction arms, through the removal of the axial direction arms, the effective surface area for cooling of the stator iron core 6 is increased, as a result, cooling performance of the machine can be improved.

Still further, since the securing of the stator iron core 6 to the frame 1 is modified from the shrink fitting to the partial welding, assembling work thereof can be eased.

In a test using an actual machine, it was confirmed that the test result with regard to vibration and temperature rise are desirable in comparison with the conventional structure.

As has been explained above, through the improvement of the frame structure and the securing method between the stator iron core and the frame, the vibration and noise reduction, temperature reduction and the ease of the assembly work of the rotating electric machine can be realized.

Now, a second embodiment of the present invention will be explained with reference to the drawings.

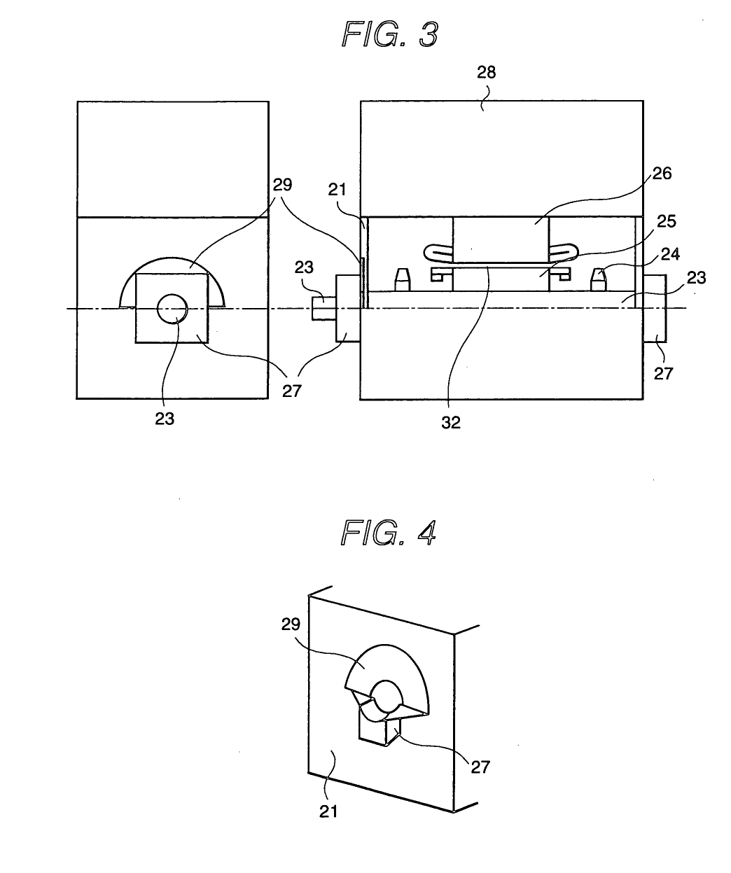

FIG. 3 shows a structure of the rotating electric machine in a vertical cross sectional view, and FIG. 4 shows a detailed view of the bracket portion thereof.

A stator iron core 26 having a stator winding is secured to the frame 21, cooling fans 24 and a rotor iron core 25 are secured to a rotor shaft 23 and bearings 27 both at load side and anti-load side are divided upper and lower into two parts and are secured to the frame 21 via the brackets 22.

For example, if the bearings 27 for supporting the rotor shaft 23 both at the load side and the anti-load side are secured as in the conventional manner to the frame 21 via brackets 22 fixed by dowel bolts, the frame 21 is required to have a large opening portion as a bracket attachment face for attaching the bracket 22 thereto. Therefore, the rigidity of the frame 21 as well as the rigidity of the entire rotating electric machine are weakened, and vibration as well as noise of the rotating electric machine increase. Further, if a load which causes a thrust loading in the axial direction of the rotating electric machine is directly coupled thereto, it is difficult to obtain a bearing attachment face having a high rigidity. Still further, since the plate thickness of the bracket is thin, the heat caused during operation of the rotating electric machine is likely to be transferred to the bearings to rise the temperature thereof. Still further, since the use of the bolts for securing brackets divided upper and lower into two part to the frame 21, number of parts increases which increases assembly time for the rotating electric machine as well as increases opportunity to be contaminated by foreign matters. In addition, as a result of the increased parts number, the entire weight of the rotating electric machine increases.

For the above reason, in the rotating electric machine according to the present embodiment, which includes a frame 21, a stator iron core 26 having a stator winding, a rotor iron core 25 having a rotor winding, a brackets 22 which support the rotor at both axial ends of the frame 21 under a condition of accommodating the stator iron core 26 and the rotor iron core 25 in the frame 21, cooling fans 24 for ventilation through rotation together with the rotor shaft 23 and a shaft extending from one of the brackets for directly coupling with a load, wherein one of the bearing and bracket structures is formed in an integral structure with the frame.

The bearing 27 for supporting the rotor shaft 23 is directly attached to the frame 21. In this instance, size of an opening formed at a lower half of the frame 21 is designed to just permit the rotor shaft 23 to extrude therethrough and the size of an opening formed at an upper half thereof is designed to be substantially the same order of the rotor iron core 25. Further, over the opening of the upper half of the frame 21 a cover 29 is attached. Accordingly, an inspection of an air gap portion 32 can be performed by removing the cover 29 in the like manner as in the conventional rotating electric machine, which improves the maintenance property.

The above will be explained in more detail. A rotating electric machine is always accompanied with vibration during operation thereof and is required to reduce the vibration with the rotating electric machine as a whole. In this instance, it is required to reduce vibration in maximum at the bearing portions, therefore, it is required to increase rigidity at the bearing portions, for this reason the structure of the attachment portion of the bearing 27 to the frame 21 is to be rationalized so as to increase the rigidity thereof. Further, it is necessary to increase the plate thickness more than the conventional upper and lower bracket and to integrate the same with the frame and to suppress the temperature increase of the same by shielding heat from the inside of the rotating electric machine.

Further, through the integral structure of the upper and lower brackets with the frame, the assembling work is simplified and contamination by foreign matters is prevented.

As a result of measurement with regard to vibration as well as temperature rise on an actual machine, in which the rigidity of the bearing portions is increased and the brackets and the frame are constituted in an integral structure, confirmed to show a desirable result in comparison with the conventional structure.

As has be explained above, through integrating the bearing and bracket structure with the frame in the rotating electric machine, the rigidity of the machine is increased and reduction of the vibration and noise thereof are realized. Therefore, freedom in connection with electrical design with regard to combinations of slot number of the stator winding and the rotor winding which are limited in view of vibration and noise is increased. Further, since cooling performance of the bearing can be enhanced, the assembling work of the machine is simplified, and the contamination by foreign matters is prevented, the structural characteristic and reliability of the rotating electric machine can be enhanced.

Now, the third embodiment of the present invention will be explained with reference to the drawings.

With the present embodiment, through an improvement in fan guide structure, cooling performance as well as reliability of the rotating electric machine can be enhanced.

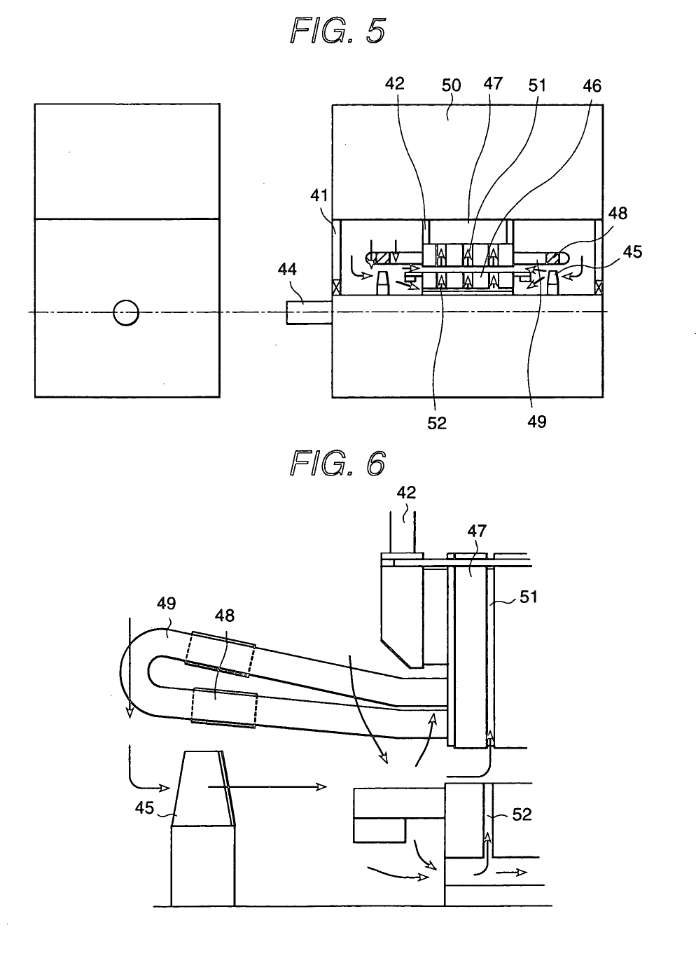

FIG. 5 shows a structure of the rotating electric machine in a vertical cross sectional view, and

FIG. 6 shows a detail structure of a fan guide portion thereof.

The rotating electric machine of the present embodiment is constituted by a stator iron core 47 having a stator winding 49, a frame 41 for securing the stator iron core 47 thereto via intermediate plates 42, a rotor iron core 46 having a rotor winding 49 and rotor ducts (rotor cooling ducts) 52, the intermediate plates (brackets) 42 which support the rotor at both sides in frame axial direction under a condition of accommodating the stator iron core 47 and the rotor iron core 46 in the frame 41 and cooling fans 45 for ventilation through rotation together with a rotor shaft 44. At the cooling fans 45 fit spacers 48 for supporting both ends of the stator winding 49 are provided.

For example, if the rotating electric machine is constituted as in the conventional one by a stator core winding 49 having fit spacers for adjacent windings, a stator iron core 47 having the stator winding 49 and stator ducts (stator cooling ducts) 51, a frame 41 having intermediate plates 42 and axial direction arms for securing the stator iron core 47 to the frame 41, a rotor iron core 46 having a rotor winding and rotor ducts (rotor cooling ducts) 52, the intermediate plates (brackets) 42 which support the rotor at both sides in frame axial direction under a condition of accommodating the stator iron core 47 and the rotor iron core 46 in the frame 41, cooling fans 45 for ventilation through rotation together with the rotor shaft 44, fan guides for the cooling fans 45 and a ventilation box (cooling use ventilation box) 50, because of the provision of the fan guides both end portions of the stator winding are not cooled sufficiently, as the result, which causes temperature rise of the stator winding 49. Further, because of the provision of the fan guides near the stator winding 49, when the fan guides are made by a metallic material, because of corona discharge from the stator winding 49, dielectric break-down of the stator winding 49 may be caused. Further, in order to prevent such dielectric break-down it is necessary to space apart the distance between the stator winding 49 and the fan guides, which prolongs the axial length of the frame 41 and results in enlarging the entire size of the rotating electric machine. Still further, because of the provision of the fan guides, number of parts of the machine also increases.

Namely, it is preferable by improving the structure around the fans to enhance the performance and reliability of the rotating electric machine, to ease the assembling work thereof and to reduce the number of parts thereof.

For this purpose, in the rotating electric machine according to the present embodiment which is constituted by a stator iron core 47 having a stator winding 49 and stator ducts (stator cooling ducts) 51, a frame 41 having intermediate plates 42 for securing the stator iron core 47 to the frame 41, a rotor iron core 46 having a rotor winding and rotor ducts (rotor cooling ducts) 52, the intermediate plates (brackets) 42 which support the rotor at both sides in frame axial direction under a condition of accommodating the stator iron core 47 and the rotor iron core 46 in the frame 41, cooling fans 45 for ventilation through rotation together with a rotor shaft 44, and a ventilation box (cooling use ventilation box) 50, wherein fit spacers 48 to be attached to the stator winding 49 are attached at positions around the outer circumference of the cooling fans 45 as well as both end portions of the stator iron core 47 are secured via the intermediate plates 42, thereby, the fit spacers are provided with a fan guide function in addition to the conventional supporting function of the stator winding 49 at both ends thereof.

Namely, in the FIGS. 5 and 6 embodiment, the fit spacers 48 functioning as the fan guides are attached on the stator winding 49 at the position around the outer circumference of the cooling fans 45.

More specifically, the fit spacers 48 are disposed around the outer circumference of the cooling fans 45 and the intermediate plates 42 are located at both ends of the stator iron core 47 for securing the same to the frame 41, further, the inletting and outletting of the cooling wind from the ventilation box 50 are separated by the intermediate plates 42.

The cooling wind in the rotating electric machine flows as shown in FIGS. 5 and 6 to cool the stator winding 49 and the stator iron core 47. In this embodiment an axial fan is used for the cooling fan 45, and it is known in general that when a fan guide is provided near the outer circumference of the axial fan, the performance thereof is enhanced. Therefore, when attaching the fit spacers 48 filled between the adjacent windings at both ends of the stator winding 49 near the outer circumferential portions of the cooling fans 45, the fan guide function is provided for the fit spacers 48. Further, since with regard to securing the stator iron core 47 including the stator winding 49 to the frame 41, both end portions of the stator iron core 47 are secured to the frame 41 via the intermediate plates 42 included therein, the inletting portion and the outletting portion of the cooling wind in the rotating electric machine can be separated by the intermediate plates 42. As a result, both ends of the stator winding 49 is cooled not only by the cooling wind from the cooling fan 45 but also by the inletting wind to the rotor ducts 52 from the cooling fan 45 which passes through both end portions of the stator winding 49. Further, as an experimental result it was confirmed that with the structure of the present embodiment the temperature rise at both end portions of the stator winding 49 was reduced by about 5 [symbol] to 10 [symbol] K in comparison with that of the conventional structure. As a result, an average temperature rise of the stator winding 49 was reduced by about 5 [symbol] K, thereby, it was confirmed that with the structure of the present embodiment the cooling performance is enhanced.

Further, with the elimination of the conventional fan guides disposed near the stator winding 49, the resistance with regard to dielectric break-down of the stator winding is enhanced, still further, since the space in axial direction required conventionally for the fan guides is unnecessitated, the length in axial direction of the rotor shaft 44, namely the length in axial direction of the frame 41 is shortened. As a result, the size of the rotating electric machine can be reduced.

Still further, because of the elimination of the conventional fan guides, the assembling work is eased, the number of parts is reduced, the weight of the rotating electric machine is lightened, and moreover, causes of contamination by foreign matters during assembling are eliminated and reliability of the machine is enhanced.

As has been explained hitherto, with the present invention, the cooling performance and reliability of the rotating electric machine are enhanced and the assembling work thereof is eased

1. A rotating electric machine which includes a frame, a stator accommodated in the frame, a rotor accommodated in the frame so as to oppose to the stator in the frame and fans provided at the outside of the rotor in the axial direction thereof in the frame and being rotatable together with the rotor and in which the stator is secured to the frame via intermediate plates, wherein the securing is performed by welding the stator to the intermediate plates.

2. A rotating electric machine according to claim 1, wherein the securing is performed by welding both end portions of the stator.

3. A rotating electric machine according to claim 2, wherein the securing is performed only by welding both end portions of the stator.

4. A rotating electric machine according to claim 3, wherein brackets are constituted at both side portions of the frame and the rotor is rotatably supported by the brackets via bearings.

5. A rotating electric machine according to claim 4, wherein the stator is secured to the frame by making use of a plurality of the intermediate plates.

6. A rotating electric machine which includes a frame, brackets provided at the side faces of the frame, a rotor rotatably supported by the brackets via bearings, a stator held in the frame so as to surround the rotor, fans disposed between the rotor and the brackets and being rotatable together with the fans and in which the brackets are formed so as to permit division thereof, wherein at least one of the divided parts of the brackets is formed integral with the frame.

7. A rotating electric machine according to claim 6, wherein the integrated structure is formed at a side where the rotor is coupled with a load.

8. A rotating electric machine according to claim 7, wherein the frame is a rectangular shape.

9. A rotating electric machine according to claim 7, wherein the bearings are directly attached to the frame.

10. A rotating electric machine according to claim 9, wherein the dividable brackets are coupled each other by dowel bolts.

11. A rotating electric machine which includes a stator iron core, a stator winding provided at the stator iron core, a rotor iron core opposing to the stator iron core and being rotatable, a rotor winding provided at the rotor iron core, fans being rotatable together with the rotor iron core and fit spacers provided at the stator winding, wherein the fit spacers are attached at a position extending from the outside of the cooling fans.

12. A rotating electric machine which includes a stator iron core, a stator winding provided at the stator iron core, a rotor iron core opposing to the stator iron core and being rotatable, a rotor winding provided at the rotor iron core, fans being rotatable together with the rotor iron core and fit spacers provided at the stator winding, wherein the fit spacers are disposed in a manner so as to overlap with the cooling fans in the radial direction thereof.

13. A rotating electric machine which includes a stator iron core, a stator winding provided at the stator iron core, a rotor iron core opposing to the stator iron core and being rotatable, a rotor winding provided at the rotor iron core, fans being rotatable together with the rotor iron core and fit spacers provided at the stator winding, wherein the fit spacers are disposed near the cooling fans.

14. A rotating electric machine according to claim 13, wherein the cooling fan is an axial type fan.

15. A rotating electric machine according to claim 14, wherein the rotating electric machine further comprises an intermediate plate which secures the stator iron core and separates inletting wind and outletting wind of the cooling fan.

16. A rotating electric machine according to claim 15, wherein the rotating electric machine further comprises a frame for securing the stator via the intermediate plate.

17. A rotating electric machine according to claim 16, wherein the rotating electric machine further comprises a bracket for supporting the rotor.

18. A rotating electric machine comprises a frame, a stator iron core having a stator winding and stator cooling ducts, intermediate plates provided at the frame for securing the stator iron core to the frame, a rotor iron core having a rotor winding and rotor cooling ducts, brackets which support the rotor at both side in axial direction of the frame under a condition of accommodating the stator iron core and the rotor iron core in the frame, a cooling fan for ventilation being rotated together with a rotating shaft of the rotor, and fit spacers attached to the stator winding around the outer circumferential portion of the cooling fan.
